(19) United States
(12) Patent Application Publication
(10) Pub. No.: US 2014/0123813 A1
(43) Pub. Date: May 8, 2014

(54) Combination Can and Bottle Opener

(71) Applicant: HAMILTON BEACH BRANDS, INC., Glen Allen, VA (US)

(72) Inventor: Dennis Leung, Wong Chuk Hang (HK)

(73) Assignee: Hamilton Beach Brands, Inc., Glen Allen, VA (US)

(21) Appl. No.: 13/669,925

(22) Filed: Nov. 6, 2012

(51) Int. Cl. B67B 7/44; B65B 69/00

(52) U.S. Cl. 81/3.09; 53/492

(57) ABSTRACT

A combination can and bottle opener includes a housing, a power supply, a motor and a gear train. A wheel extends at least partially outside of the housing and is operatively connected by the gear train to the motor. At least a portion of the wheel is configured to engage at least a portion of a can such that the can rotates with the wheel. A lever is pivotally attached to the housing between a first position for accommodating at least a portion of the can and a second position for engaging and opening the can as the can rotates with the wheel. A corkscrew is at least partially surrounded by the housing. The gear train operatively connects the corkscrew to the motor such that the corkscrew rotates with respect to the housing upon actuation of the motor to engage a cork to facilitate removal of the cork from a bottle.

### FIELD OF THE DISCLOSURE

The present disclosure relates generally to a combination can and bottle opener appliance and, more particularly, to a device that employs a single motor and a single gear train to operate two separate mechanisms for opening both a can and a bottle.

### BACKGROUND OF THE DISCLOSURE

Foodstuff, be it a solid, liquid or combination thereof, comes in a variety of metallic, glass and/or plastic containers and packages. To protect the foodstuff during shipping, ensure that the foodstuff is fresh, and to prevent tampering with the product, the containers and packages are tightly closed and often difficult to open with bare hands alone.

It is heretofore not been discovered how to create a single appliance with a single motor and a single gear train that operates two separate tools to open both cans and bottles. The device of the following disclosure accomplishes these objectives and other objectives.

### BRIEF SUMMARY OF THE DISCLOSURE

Briefly stated, one aspect of the present disclosure is directed to a combination can and bottle opener including a housing at least partially enclosing a power supply, a motor and a gear train. The motor is operatively connected to the power supply and the gear train. A wheel extends at least partially outside of the housing. The gear train operatively connects the wheel to the motor such that the wheel rotates with respect to the housing upon actuation of the motor. At least a portion of the wheel is configured to engage at least a portion of a can such that the can rotates with the wheel. A lever is pivotally attached to the housing. The lever is pivotable between a first position for accommodating at least a portion of the can and a second position for engaging and opening the can as the can rotates with the wheel. A corkscrew is also at least partially surrounded by the housing. The gear train operatively connects the corkscrew to the motor such that the corkscrew rotates with respect to the housing upon actuation of the motor to engage a cork to facilitate removal of the cork from a bottle.

Another aspect of the present disclosure is directed to a method of operating a combination can and bottle opener including actuating a motor within a housing and placing the combination can and bottle opener in a first orientation such that a cutting blade thereof engages and cuts into at least a portion of a can. The method further includes placing the combination can and bottle opener in a second orientation such that a corkscrew thereof engages a cork to facilitate removal of the cork from a bottle. A longitudinal axis of the housing in the first orientation extends generally perpendicularly to the longitudinal axis of the housing in the second orientation.

In yet another aspect, the present disclosure is directed to a combination can and bottle opener including at least one battery and a reversible motor operatively connected to the at least one battery. A gear train is operatively connected to the motor and is driven by the motor. A housing at least partially encloses the at least one battery, the motor and the gear train. A wheel is operatively connected to the motor by the gear train such that the wheel is rotated by the motor upon actuation of the motor. The wheel extends at least partially outside of the housing. The wheel engages at least a portion of the can such that the can rotates with respect to the wheel. A lever is pivotally attached to the housing. The lever includes a magnetized arm and a cutting blade for engaging and opening the can as the can rotates with the wheel. A corkscrew is at least partially surrounded by the housing. The corkscrew is operatively connected to the motor by the gear train such that the corkscrew is rotated upon actuation of the motor in a first rotational direction to screw into a cork to facilitate removal of the cork from a bottle and a second rotational direction to remove the cork from the corkscrew.

### BRIEF DESCRIPTION OF THE SEVERAL VIEWS OF THE DRAWINGS

The foregoing summary, as well as the following detailed description of the disclosure, will be better understood when read in conjunction with the appended drawings. For the purpose of illustrating the disclosure, there is shown in the drawings an embodiment which is presently preferred. It should be understood, however, that the disclosure is not limited to the precise arrangements and instrumentalities shown.

In the drawings:

FIG. 1 is a top perspective view of a combination can and bottle opener according to a preferred embodiment of the present disclosure, wherein the combination can and bottle opener is shown in a second orientation for facilitating removal of a cork from a bottle;

FIG. 2 is a bottom perspective view thereof;

FIG. 3 is a perspective view of a portion of the combination can and bottle opener of FIG. 1, wherein the combination can and bottle opener is shown in a first orientation for opening a can and a lever is shown in a first position;

FIG. 4 is a perspective view thereof, wherein the lever is shown in a second position;

FIG. 5 is a bottom perspective view of the combination can and bottle opener in the second orientation, wherein certain portions are removed for clarity;

FIG. 6 is a top perspective view of a portion of the combination can and bottle opener, wherein certain portions are removed for clarity;

FIG. 7 is another top perspective view of a portion of the combination can and bottle opener, wherein certain portions are removed for clarity; and

FIG. 8 is yet another top perspective view of a portion of the combination can and bottle opener, wherein certain portions are removed for clarity.

### DETAILED DESCRIPTION OF THE DISCLOSURE

Certain terminology is used in the following description for convenience only and is not limiting. The words “lower,” “bottom,” “upper” and “top” designate directions in the drawings to which reference is made. The words “inwardly,” “outwardly” and “upwardly” refer to directions toward and away from, respectively, the geometric center of the device, and designated parts thereof, in accordance with the present disclosure. Unless specifically set forth herein, the terms “a,” “an” and “the” are not limited to one element, but instead should be read as meaning “at least one.” The terminology includes the words noted above, derivatives thereof and words of similar import.

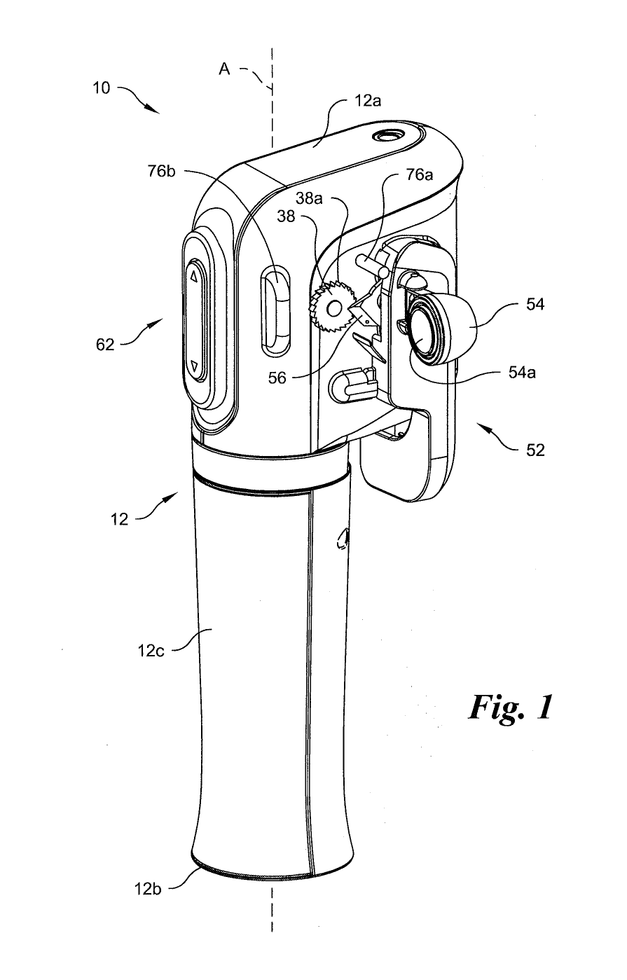

Referring to the drawings in detail, wherein like numerals indicate like elements throughout, FIGS. 1-8 illustrate a combination can and bottle opener (“device”), generally designated 10, according to a preferred embodiment of the present disclosure. The device 10 is preferably a relatively light-weight, relatively small, hand-held, self-powered appliance that allows a user to easily, quickly and automatically open any one of a variety of metallic, glass and/or plastic containers or packages that typically contain foodstuff, such as soup or wine. More particularly, the device 10 preferably allows a user to open one of at least two separate and distinct foodstuff containers and packages without requiring the user to employ or purchase a second tool or appliance. In other words, the device 10 of the present disclosure is able to complete the operations of more than one prior art device, such as a typical can opener and a typical bottle opener.

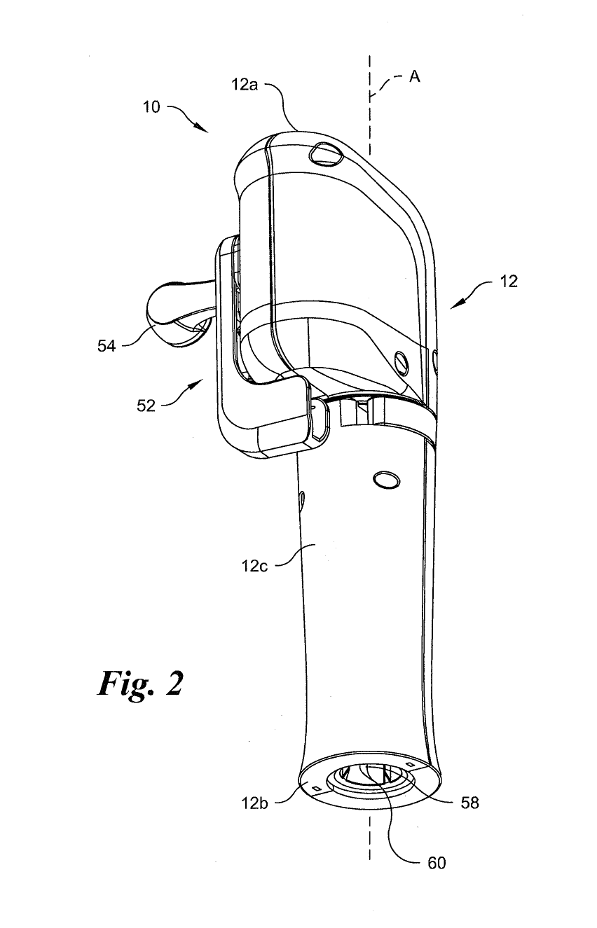

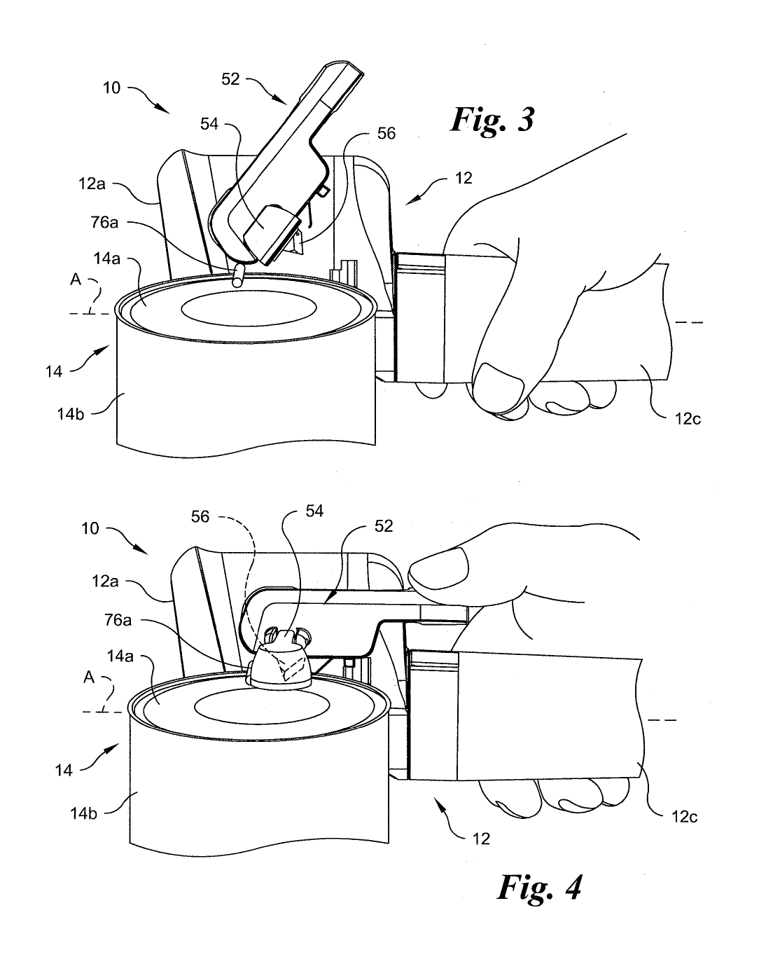

Referring to FIGS. 1-4, the device 10 includes a housing 12 that preferably includes a first or top end 12a and an opposing second or bottom end 12b. The housing 12 defines a longitudinal axis A that extends from the first end 12a to the second end 12b. The housing 12 is preferably positionable in both a first orientation (see FIGS. 3 and 4) and a second orientation (see FIGS. 1 and 2). In the first orientation, the device 10 is configured to open a can 14, such as by cutting and removing a lid 14a from a base 14b of the can 14. In the second orientation, it is preferred that the device 10 is configured to remove a cork (not shown) from a bottle (not shown). It is preferred that the longitudinal axis A of the housing 12 in the first orientation (see FIGS. 3 and 4) extends generally, if not exactly, perpendicularly to the longitudinal axis A of the housing 12 in the second orientation (see FIGS. 1 and 2).

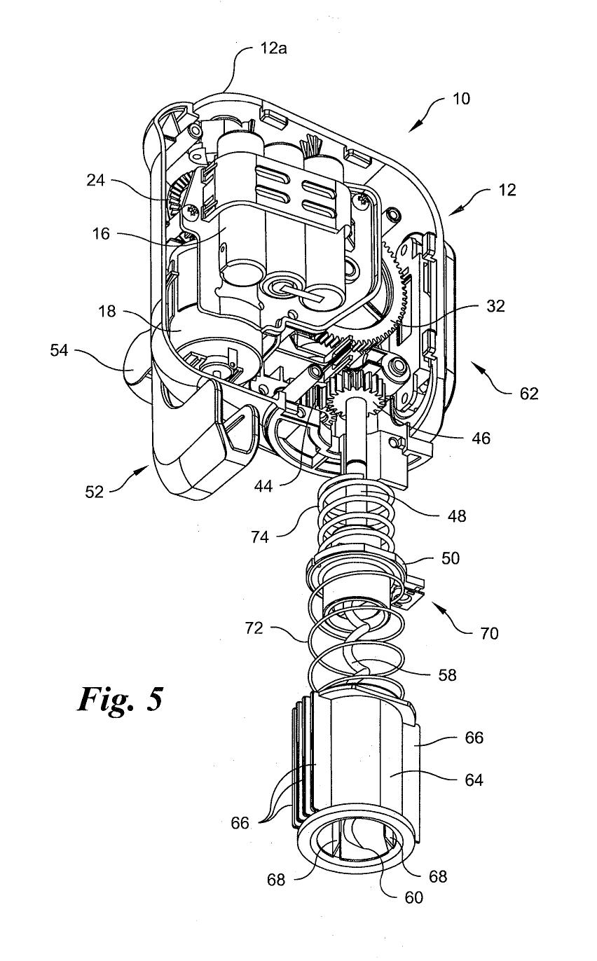

Referring to FIGS. 5-8, the housing 12 preferably at least partially encloses or otherwise surrounds a power supply 16, a motor 18 and a gear train 20. The motor 18 is preferably operatively connected to the power supply 16 and the gear train 20. In a preferred embodiment, the power supply 16 is at least one and more preferably at least two batteries. The power supply 16 may be a set of three alkaline or NiCd batteries (as shown) having a standard battery designation “AA” or “AAA.” However, any battery (or two or more batteries) delivering electric power at the appropriate voltage and current levels can be used. The battery 16 may be of a rechargeable type for convenient long-lasting operation without frequent battery 16 replacement. Alternatively, the power supply 16 may be a power cord that operatively connects the device 10 to a conventional wall outlet (not shown). The motor 18 is preferably an electric, reversible DC motor designed for relatively high torque operation while drawing a current below maximum amounts of current deliverable from a battery 16. When power is supplied to the motor 18, it is preferred that the motor 18 operates both the can opener and the bottle opener, as described in detail below, regardless of whether a can or a bottle is properly positioned with respect to the device 10 so as to be opened by the device 10.

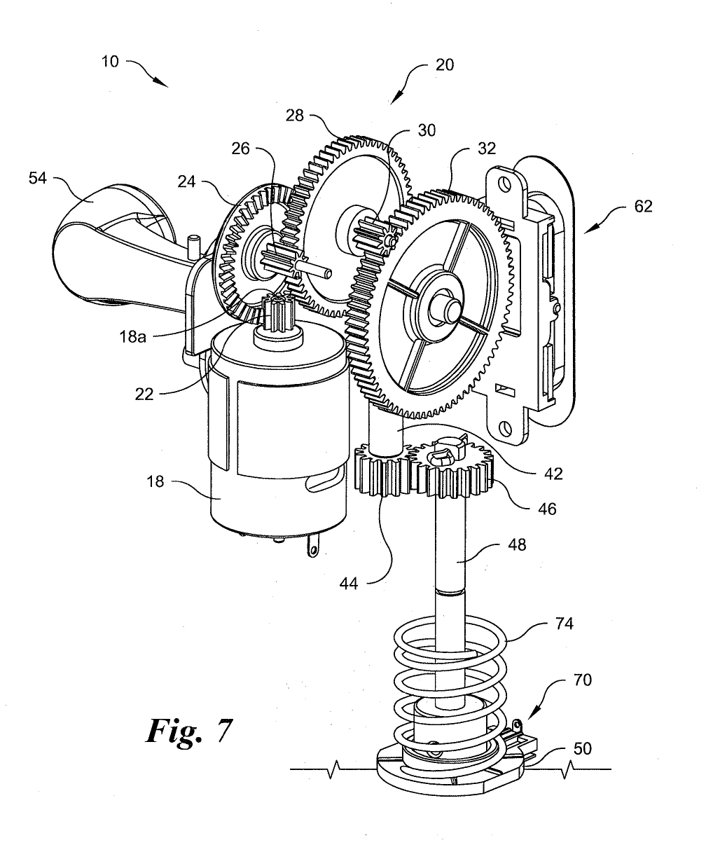

Referring again to FIGS. 5-8, the gear train 20 is preferably a gear reduction system that reduces the speed and increases the torque at which the motor 18 operates the device 10, as described in detail below. Specifically, as shown if FIG. 7, a drive shaft 18a of the motor 18 is preferably fixedly attached to and rotates a small pinion 22. The pinion 22 rotatably engages (e.g., rotatable with respect to) a larger first reduction gear 24, such that rotation of the pinion 22 by the drive shaft 18a of the motor 18 rotates the first reduction gear 24 at a reduced speed. The first reduction gear 24 is fixedly attached to and rotatably engages a small second pinion 26. The second pinion 26 is preferably fixedly attached to a mid-portion of the first reduction gear 24, but the present disclosure is not so limited. The second pinion 26 is rotatably engaged with a larger second reduction gear 28. The second reduction gear 28 is fixedly attached to and rotates a small third pinion 30. The third pinion 30 is preferably fixedly attached to a mid-portion of the second reduction gear 28, but the present disclosure is not so limited. The third pinion 30 rotatably engages with a large third reduction gear 32.

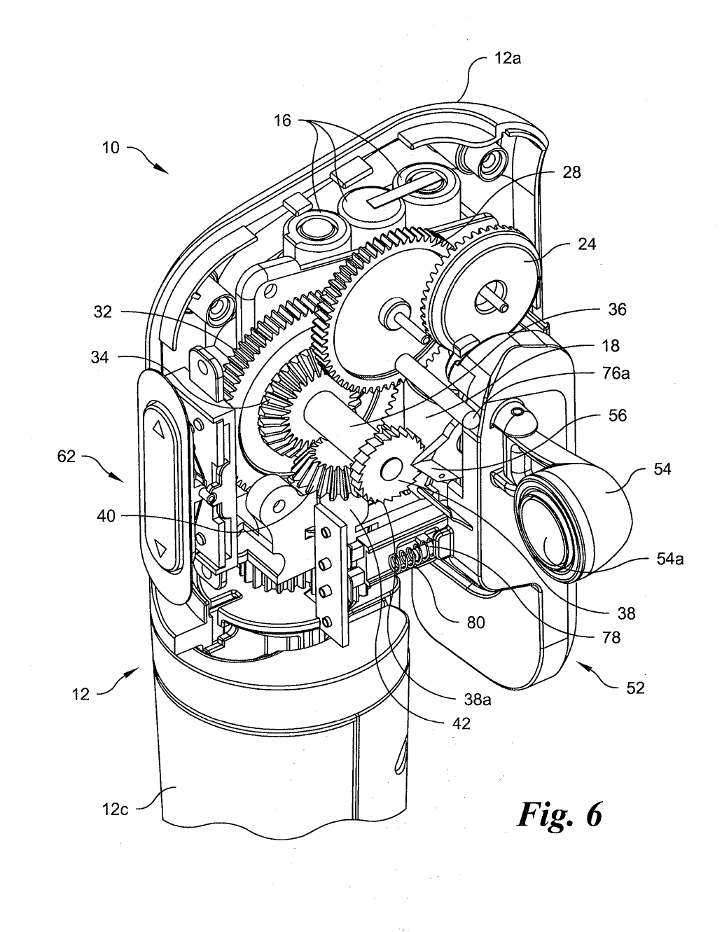

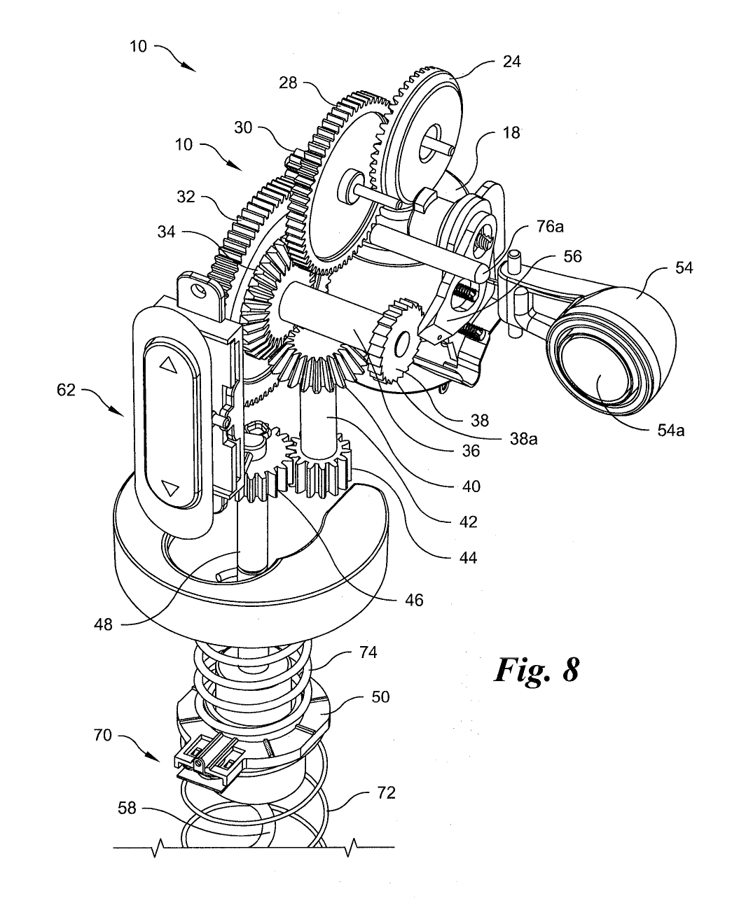

Referring now to FIGS. 6 and 8, the third reduction gear 32 of the gear train 20 is preferably fixedly attached to and rotates a first bevel gear 34. The first bevel gear 34 is preferably fixedly attached to a mid-portion of the third reduction gear 32, but the present disclosure is not so limited. The first bevel gear 34 is preferably the portion of the gear train 20 that permits the device 10 to operate two separate tools, as described in detail below, for opening foodstuff containers and/or packages. In other words, the first bevel gear 34 is where the gear train 20 splits or divides into the drivers for the can opener portion and the bottle opener portion.

As part of the can opener portion of the gear train 20, the first bevel gear 34 is preferably fixedly attached to and rotates a first shaft 36. The first shaft 36 preferably extends generally, if not exactly, perpendicularly to the longitudinal axis A of the housing 12. The first shaft 36 preferably forms no part of and does not effect operation of the bottle opener portion of the device 10. A wheel 38, as described in detail below, is preferably fixedly attached to an end of the first shaft 36 opposite the first bevel gear 34. Actuation of the motor 18 rotates the wheel 38 (at a greatly reduced speed but with increased torque) through the relevant components of the gear train 20.

Referring to FIGS. 1-6 and 8, the wheel 38 preferably extends at least partially outside of the housing 12. It is preferred that the wheel 38 includes one or more angled teeth, prongs or spikes 38a on an outer periphery thereof to increase a friction force between the wheel 38 and any object (i.e., a can 14) that the wheel 38 engages. As described above, the gear train 20 preferably operatively connects the wheel 38 to the motor 18 such that the wheel 38 rotates with respect to the housing 12, which is preferably held stationary by a user's hand (see FIGS. 3 and 4) upon actuation of the motor 18. At least a portion of the wheel 38, such as the spikes 38a, are preferably configured to engage at least a portion of the can 14 such that the can 14 rotates with the wheel 38. In particular, it is preferred that at least some of the spikes 38a engage the can 14 just beneath the upper rim thereof, but the present disclosure is not so limited.

Referring to FIGS. 1-8, the device 10 preferably includes a lever 52 pivotally attached to the housing 12. The lever 52 includes an arm 54, having a magnet 54a, and a cutting blade 56, which allows the device 10 to engage and open the can 14 as the can 14 rotates with the wheel 38 (for example, counterclockwise from the perspective of FIGS. 1 and 6). The lever 52, as well as the arm 54, the magnet 54a and the cutting blade 56, is preferably pivotable with respect to the housing 12 between a first position (see FIG. 3) and a second position (see FIG. 4). As shown in FIG. 3, it is preferred that in the first position, the lever 52 accommodates or allows at least a portion of the can 14 to be placed proximate to the wheel 38. As shown in FIG. 4, it is preferred that in the second position, at least a portion of the lever 52, such as the cutting blade 56, engages one of the lid 14a and the body 14b of the can 14 to open the can 14 as the can 14 rotates with the wheel 38 in a manner well known in the art. In particular, it is preferred that in the second position, the cutting blade 56 pierces a portion of the lid 14a of the can 14 as the wheel 38 rotates the can 14 with respect to the cutting blade 56. The magnet 54a within the arm 54 engages the lid 14a to remove and hold the lid 14a after the can 14 has been opened.

The can opener portion of the device 10 may be actuated upon pivoting the arm 54 to the second position shown in FIG. 4. For example, as shown in FIG. 6, a switch 78 positioned within a portion of the housing 12 may be “open” when the arm 54 is in the first position shown in FIG. 3. When the arm 54 is pivoted to the second position shown in FIG. 4, the switch may be “closed” such that power is automatically supplied to the motor 18 to rotate the wheel 38 in the direction necessary to rotate a can 14 to allow the cutting blade 56 to cut into and separate a lid 14a from the body of the can 14. A spring 80 may surround or positioned proximate the switch 78 to bias the switch 78 in the “open” position unless the arm 54 is moved to the second position.

As part of the bottle opener portion of the gear train 20, the first bevel gear 34 preferably forms a bevel gear set with a second bevel gear 40. The second bevel gear 40 is preferably fixedly attached to and rotates a second shaft 42. The second shaft 42 preferably extends generally, if not exactly, parallel to the longitudinal axis A of the housing 12. As shown in FIG. 8, the second shaft 42 also preferably extends generally, if not exactly, perpendicularly to the first shaft 36 described above. A small fourth pinion 44 is preferably fixedly attached to an end of the second shaft 42 opposite the second bevel gear 40. The fourth pinion 44 is preferably rotated by the second shaft 42. The fourth pinion 44 preferably rotatably engages a small fifth pinion 46. As shown in FIG. 7, the fourth pinion 44 is preferably positioned laterally to the fifth pinion 46 when the device 10 is in the second orientation (see FIGS. 1 and 2). The fifth pinion 46 is fixedly attached to one end of a third shaft 48. The third shaft 48 preferably extends generally, if not exactly, parallel to the longitudinal axis A of the housing 12 and the second shaft 42. As shown in FIG. 5, a corkscrew 58 is preferably fixedly attached to the third shaft 48 at an end of the third shaft 48 opposite the fifth pinion 46.

Referring now to FIGS. 2 and 5, the corkscrew 58 is preferably at least partially surrounded by the housing 12. In particular, it is preferred that the housing 12 includes an outer sleeve 12c (see Figs. FIGS. 2-4 and 6) that is preferably generally cylindrical in shape and is generally positioned around the corkscrew 58. A first or upper end of the corkscrew 58 is preferably directly or indirectly fixed with respect to the third shaft 48, such that rotation of the third shaft 48 rotates the corkscrew 58. An opposing second or lower end of the corkscrew 58 includes a sharpened tip 60, which is designed to engage, penetrate and/or screw into a cork of a bottle. The corkscrew 58 is preferably operatively connected to the motor 18 by the gear train 20, as described above, such that the corkscrew 58 is rotated upon actuation of the motor 18. In particular, it is preferred that the motor 18 rotates the corkscrew 58 in a first rotational direction (i.e., clockwise when viewed from above) to engage a cork and/or to screw into a cork to facilitate removal of the cork from a bottle, and a second rotational direction (i.e., counterclockwise when viewed from above) to remove a cork from the corkscrew 58.

Referring to FIGS. 1 and 5-8, the device 10 preferably includes a reverse switch 62 mounted to the housing 12. The reverse switch 62 is preferably operatively connected to the motor 18 for selectively applying power from the power supply 16 to the motor 18 for operation of the motor 18, such that operation of the motor 18 in one direction rotates the corkscrew 58 in the first rotational direction and operation of the motor 18 in a reverse direction rotates the corkscrew 58 in the second rotational direction. The reverse switch 62 is preferably a toggle or slide switch in which at least a portion thereof is depressible laterally inwardly toward the housing 12. For example, an upper end of the reverse switch 62 may be depressible to rotate the motor 18 in one direction and a lower end of the reverse switch 62 may be depressible to rotate the motor 18 in the reverse direction. However, any type of switch or control may be used to selectively reserve operation of the motor 18.

Referring to FIGS. 5, 7 and 8, the device 10 preferably includes a first shuttle 64 and a second shuttle 50. The first shuttle 64 is preferably movable along the longitudinal axis A of the housing 12 with respect to the second shuttle 50. However, it is preferred that each of the first and second shuttles 64, 50 are not rotatable or rotatably fixed with respect to the housing 12. Each of the first and second shuttles 64, 50 preferably surround at least a portion of the corkscrew 58 and each of the first and second shuttles 64, 60 are preferably positioned within the outer sleeve 12c of the housing 12. The second shuttle 50 is preferably surrounds and/or is rotatably attached to an end of the third shaft 48 opposite the fifth pinion 46. For example, a bearing (not shown) within the second shuttle 50 may allow the third shaft 48 and the corkscrew 58 to rotate while the second shuttle 50 remains rotatably fixed.

As shown in FIG. 5, the first shuttle 64 includes at least one and preferably four circumferentially spaced-apart ribs 66 extending radially outwardly in parallel on each of two opposing exterior sides of the shuttle 64. The ribs 66 of the first shuttle 64 are preferably sized, shaped and/or configured to receive and/or engage complimentary ribs (not shown) on an interior surface of the outer sleeve 12c of the housing 12 to facilitate axial movement of the first shuttle 64 with respect to the outer sleeve 12c of the housing 12. Alternatively, one or more ribs (not shown) on an interior surface of the outer sleeve 12c of the housing 12 may complimentary engage one or more grooves (not shown) in the exterior surface of the first shuttle 65. Further, an interior surface of the first shuttle 64 includes at least one and preferably a plurality of spaced-apart ribs 68 extending radially inwardly therefrom for engaging at least a portion of a cork of a bottle, as described in detail below.

Referring to FIGS. 5, 7 and 8, a shut-off switch 70 is preferably mounted to the second shuttle 50. A first biasing member 72, such as a coil spring, is preferably positioned between the first shuttle 64 and the second shuttle 50 and within the outer sleeve 12c of the housing 12. The first biasing member 72 preferably maintains a predetermined distance between the first and second shuttles 64, 50 prior to operation of the device 10 to remove a cork from a bottle. A second biasing member 74, such as a coil spring, is preferably positioned within the outer sleeve 12c of the housing 12. The second biasing member 74 is preferably positioned between an upper end of the outer sleeve 12c of the housing 12 and a top or upper surface of the second shuttle 50. The second biasing member 74 preferably biases the shut-off switch 70 in a closed position, which maintains power to the motor 18. If and when the downwardly biasing force of the second biasing member 74 is overcome, as described below, the shut-off switch 70 is permitted to move to an open position, which cuts power to the motor 18 and prevents opening a can 14 or a bottle.

Both the first and second biasing members 72, 74 preferably extend along the longitudinal axis A of the housing 12, with the first biasing member 72 being proximate the second end 12b of the housing 12. The second biasing member 74 is preferably closer to the first end 12a of the housing 12 than the first biasing member 74. A spring constant of the second biasing member 74 is preferably greater than a spring constant of the first biasing member 72.

In operation, when a user desires to remove a cork from a bottle, the device 10 is preferably positioned in the second orientation (see FIGS. 1 and 2). The second end 12b of the housing 12 is preferably placed near or on top of an upper end of a bottle, such that the tip 60 of the corkscrew 58 contacts or is in close proximity to an upper surface of a cork within the bottle. Power is preferably supplied to the motor 18 such that the corkscrew 58 rotates in the first rotational direction and screws into the cork. Power may be supplied to the motor 18 in any one of a number of ways, such as by depressing an on/off button (not shown) on the housing and/or depressing or otherwise actuating the reverse switch 62. Upon actuation of the motor 18, as the corkscrew 58 begins to screw into the cork, at least a portion of the second end 12b of the housing 12 preferably holds the bottle in place. As the cork is moved upwardly and out of the bottle, the ribs 68 on the interior surface of the first shuttle 64 preferably engage at least a portion of the cork, which assists in removing the cork from the bottle.

As the motor 18 continuously operates, the corkscrew 58 and the first shuttle 64 continue to move the cork out of the bottle, and the first shuttle 64 moves upwardly within the outer sleeve 12c of the housing 12. As the first shuttle 64 moves upwardly within the outer sleeve 12c of the housing 12, the first biasing member 72 begins to compress against the second sleeve 50. The above-described operation continues until the first biasing member 72 is compressed to a predetermined point, at which point the second shuttle 50 begins to move at least slightly upwardly toward the third shaft 48. As the second shuttle 50 begins to move upwardly, perhaps only slightly, the shut-off switch 70 is opened, thereby shutting off power to the motor 18 and causing the motor 18 to stop. At this point, the cork is preferably completely removed from the bottle. To remove a cork from the corkscrew 58, it is preferred that the user reverses operation of the motor 18, such as through operation of the reverse switch 62, which rotates the corkscrew 58 in the second rotational direction, thereby allowing the cork to be removed from the corkscrew 58.

To open a can 14, the device 10 is preferably positioned in the first orientation (see FIGS. 3 and 4). To properly position the housing 12 with respect to the can 14, one or more projections 76a, 76b (see FIG. 1) preferably extend laterally outwardly from the housing 12. It is preferred that the lever 52 is placed or otherwise moved to the first position (see FIG. 3) to allow the can 14 to be properly positioned with respect to the housing 12. The motor 18 may be actuated by movement of the lever 52 from the first position (FIG. 3) to the second position (FIG. 4), as described in detail above. However, the motor 18 may be actuated in any one of a number of ways, such as by depressing the on/off button (not shown) on the housing 12, which may “close” the switch 78.

The motor 18 is preferably operated so as to rotate the wheel 38 through the gear train 20. As the wheel 38 is rotated, the spikes 38a thereof preferably engage at least a portion of the can 14 and begin to rotate the can 14. In the second position (FIG. 4), the cutting blade 56 of the lever 52 56 engages and preferably pierces the lid 14a on the can 14. As the wheel 48 continues to rotate the can 14, the cutting blade 56 continues to pierce the lid 14a of the can 14 preferably around a periphery of the lid 14a. The magnet 54a of the arm 54 preferably engages the lid 14a of the can 14 and prevents the lid 14a from falling within the base 14b of the can 14 during cutting. It is preferred that the device 10 can open the can 14 regardless of the operation (i.e., forward vs. reverse) of the motor 18.

A method of operating the device 10 includes actuating the motor 18 within the housing 12 and placing the device 10 in the first orientation (see FIG. 4) such that the cutting blade 56 thereof engages and cuts into at least a portion of the can 14. The motor 18 may be actuated before or after the device 10 is placed in the first orientation. The method further includes rotating the wheel 38 with respect to the housing 12 and engaging at least a portion of the wheel 38 with at least a portion of the can 14, such that the can 14 rotates with the wheel 38. The method preferably includes rotating the lever 52 that is pivotally attached to the housing 12 to the first position (see FIG. 3) for accommodating at least a portion of the can 14 and rotating the lever 52 to the second position (see FIG. 4) for engaging and opening the can 14. The method further preferably includes placing the device 10 in the second orientation (see FIGS. 1 and 2) such that the corkscrew 58 thereof engages a cork to facilitate removal of the cork from a bottle. The method preferably includes actuating the reverse switch 62 mounted to the housing 12 to reverse operation of the motor 18 to remove the cork from the corkscrew 58.

It will be appreciated by those skilled in the art that changes could be made to the embodiments described above without departing from the broad inventive concept thereof. It is understood, therefore, that this disclosure is not limited to the particular embodiments disclosed, but it is intended to cover modifications within the spirit and scope of the present disclosure as defined by the appended claims.

I/We claim:

1. A combination can and bottle opener comprising:
a housing at least partially enclosing a power supply, a motor and a gear train, the motor being operatively connected to the power supply and the gear train;
a wheel extending at least partially outside of the housing, the gear train operatively connecting the wheel to the motor such that the wheel selectively rotates with respect to the housing upon actuation of the motor, at least a portion of the wheel being configured to engage at least a portion of a can such that the can rotates with the wheel;
a lever pivotally attached to the housing, the lever being pivotable between a first position for accommodating at least a portion of the can and a second position for engaging and opening the can as the can rotates with the wheel; and
a corkscrew at least partially surrounded by the housing, the gear train operatively connecting the corkscrew to the motor such that the corkscrew selectively rotates with respect to the housing upon actuation of the motor to engage a cork to facilitate removal of the cork from a bottle.

2. The combination can and bottle opener according to claim 1, wherein the housing defines a longitudinal axis, the housing being positionable in a first orientation to open the can and a second orientation to remove the cork from the bottle, the longitudinal axis of the housing in the first orientation extending generally perpendicularly to the longitudinal axis of the housing in the second orientation.

3. The combination can and bottle opener according to claim 1, wherein the motor is reversible.

4. The combination can and bottle opener according to claim 3, further comprising:
a switch mounted to the housing and operatively connected to the motor for selectively reversing operation of the motor, wherein operating the motor in one direction rotates the corkscrew in a first rotational direction and operating the motor in a reverse direction rotates the corkscrew in a second rotational direction.

5. The combination can and bottle opener according to claim 1, wherein the power supply comprises at least one battery.

6. The combination can and bottle opener according to claim 1, further comprising:
a first shuttle surrounding at least a portion of the corkscrew and positioned within the housing, the first shuttle being movable with respect to the housing along a longitudinal axis thereof, the first shuttle including at least one rib extending inwardly from an interior surface thereof for engaging at least a portion of the cork.

7. The combination can and bottle opener according to claim 6, further comprising:
a second shuttle surrounding at least a portion of the corkscrew and positioned within the housing;
a shut-off switch mounted to the second shuttle;
a first biasing member positioned between the first shuttle and the second shuttle to maintain a predetermined distance between the first shuttle and the second shuttle.

8. The combination can and bottle opener according to claim 7, further comprising:
a second biasing member positioned within the housing, one end of the second biasing member engaging the second shuttle and biasing the second shuttle toward a tip of the corkscrew to maintain the shut-off switch in a closed position.

9. A method of operating a combination can and bottle opener, the method comprising:
actuating a motor within a housing;
placing the combination can and bottle opener in a first orientation such that a cutting blade thereof engages and cuts into at least a portion of a can; and
placing the combination can and bottle opener in a second orientation such that a corkscrew thereof engages a cork to facilitate removal of the cork from a bottle,
wherein a longitudinal axis of the housing in the first orientation extends generally perpendicularly to the longitudinal axis of the housing in the second orientation.

10. The method according to claim 9, further comprising:
actuating a switch mounted to the housing to reverse operation of the motor to remove the cork from the corkscrew.

11. The method according to claim 9, further comprising:
rotating a lever pivotally attached to the housing to a first position for accommodating at least a portion of the can; and
rotating the lever to a second position for engaging and opening the can.

12. The method according to claim 9, further comprising:
rotating a wheel with respect to the housing; and
engaging at least a portion of the wheel with at least a portion of the can such that the can rotates with the wheel.

13. A combination can and bottle opener comprising:
at least one battery;
a reversible motor operatively connected to the at least one battery;
a gear train operatively connected to the motor and being driven by the motor;
a housing at least partially enclosing the at least one battery, the motor and the gear train;
a wheel operatively connected to the motor by the gear train such that the wheel is rotated by the motor upon actuation of the motor, the wheel extending at least partially outside of the housing, the wheel engaging at least a portion of a can such that the can rotates with respect to the wheel;
a lever pivotally attached to the housing, the lever including an arm and a cutting blade engaging and opening the can as the can rotates with the wheel; and
a corkscrew at least partially surrounded by the housing, the corkscrew being operatively connected to the motor by the gear train such that the corkscrew is rotated upon actuation of the motor in a first rotational direction to screw into a cork to facilitate removal of the cork from a bottle and a second rotational direction to remove the cork from the corkscrew.

14. The combination can and bottle opener according to claim 13, further comprising:
a first shuttle surrounding at least a portion of the corkscrew and positioned within the housing, the first shuttle being movable with respect to the housing along a longitudinal axis thereof, the first shuttle including at least one rib extending inwardly from an interior surface thereof for engaging at least a portion of the cork.

15. The combination can and bottle opener according to claim 14, further comprising:
a second shuttle surrounding at least a portion of the corkscrew and positioned within the housing;
a shut-off switch mounted to the second shuttle;
a first biasing member positioned between the first shuttle and the second shuttle to maintain a predetermined distance between the first shuttle and the second shuttle.

16. The combination can and bottle opener according to claim 15, further comprising:
a second biasing member positioned within the housing, one end of the second biasing member engaging the second shuttle and biasing the second shuttle toward a tip of the corkscrew to maintain the shut-off switch in a closed position.

17. An appliance comprising:
a housing at least partially enclosing an electric motor;
a gear train connected to the motor;
a wheel operatively connected to the motor by the gear train such that the wheel is selectively rotated by the motor upon actuation of the motor, the wheel extending at least partially outside of the housing;
a lever pivotally attached to the housing, the lever including an arm and a cutting blade;
a corkscrew, the corkscrew being operatively connected to the motor by the gear train such that the corkscrew is selectively rotated upon actuation of the motor in a first rotational direction; and
wherein the motor is reversible such that the corkscrew is selectively rotated upon actuation of the motor in a second rotational direction.
